(19) United States
(12) Patent Application Publication
(10) Pub. No.: US 2025/0194582 A1
(43) Pub. Date: Jun. 19, 2025

(54) GAME CALL BARREL

(71) Applicant: Welker, Inc., Sugar Land, TX (US)

(72) Inventor: Josh H. Welker, Richmond, TX (US)

(21) Appl. No.: 18/543,783

(22) Filed: Dec. 18, 2023

(51) Int. Cl. A01M 31/00

(52) U.S. Cl. CPC A01M 31/004

(57) ABSTRACT

An improved game call barrel is provided with a mouthpiece, a compression region, and a body region. The game call is configured and sized to allow a user to keep an adequate seal between their lips and the game call barrel.

### TECHNICAL FIELD

The present application relates to hunting, particularly a game call for waterfowl.

### BACKGROUND OF THE INVENTION

A traditional waterfowl call consists of a barrel, an insert, a tone board, a reed, and a wedge. The barrel is a hollow piece in which the user blows. The insert couples with the end of the barrel opposite a user's mouth and consists of the tone board, the reed, and the wedge.

In conventional waterfowl hunting, a user blows into the barrel of a waterfowl call. By manipulating the sounds and air pressure entering the game call as well as by manipulating the insert, sounds mimicking hunted game can draw game into an area. This is a difficult skill and can take practice and time to achieve. If a hunter using the game call cannot create a seal between their lips and the barrel of the game call, air will leak out and prevent a convincing call. Current game calls use a barrel with a mouthpiece end with around a one-inch opening, which provides a seal between the barrel and a user's lips when producing many common calls (e.g., a mallard duck quack or deer grunt).

Certain sounds, like those of diver ducks and sandhill crane, are difficult to make correctly while using a standard game call as it is hard to blow air out of a user's lungs correctly without air escaping the sides of the mouth. Due to the mouth shape and size required to make these calls, it is very difficult for even an experienced game call user to form a seal with the mouthpiece of a traditional barrel while making these calls. Children, the elderly, beginners, and those with weak facial muscles struggle to keep a sufficient seal with the mouthpiece of a standard game call when attempting a diver duck or sandhill crane call.

### SUMMARY OF THE INVENTION

An improved game call barrel is provided. The game call barrel may include a particularly sized and shaped mouthpiece, compression region, and a body region.

In use, one may insert a game call insert into the body portion of the improved game call. Then, a seal may be created between a mouthpiece and the user's lips. Then, a user can produce air and sound into the mouthpiece to mimic the sound of game.

### BRIEF DESCRIPTION OF THE DRAWINGS

FIG. 1 is an isometric view of an improved game call barrel.

FIG. 2 is a section view of the improved game call barrel of FIG. 1 along A-A.

### DETAILED DESCRIPTION

The disclosure is not limited in its application to the details of the configuration and arrangement of components set forth in the following description or illustrated in the accompanying drawings. The disclosure is capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

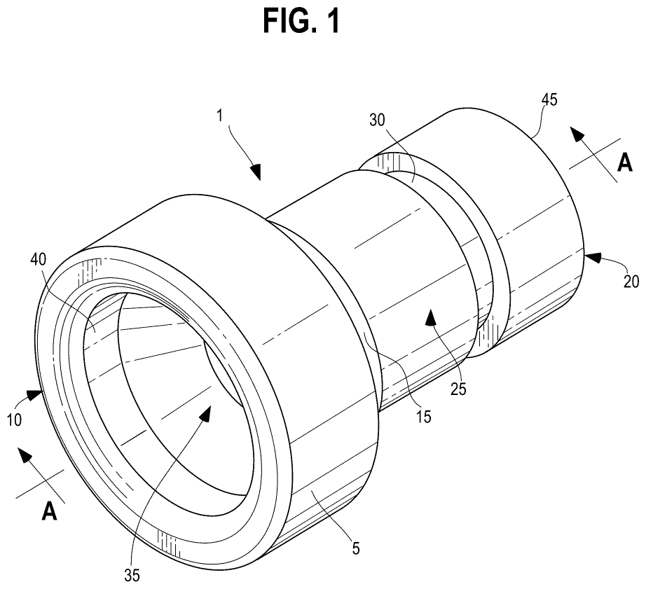

FIG. 1 illustrates an improved game call barrel 1 consisting of a mouthpiece 5 on a proximal end 10 of the game call barrel 1 to which a user may press his or her lips when in use. A tapered compression region 15 is provided adjacent to the mouthpiece 5 towards a distal end 20 of the game call barrel 1. A body region 25 is preferably provided adjacent to the compression region 15 towards the distal end 20. The body region 25 may include a recessed lanyard ring 30 circumscribing an exterior surface of the body region 25. The lanyard ring 30 provides a groove for a lanyard to couple, so that the improved game call barrel 1 can be worn around a user's neck. The improved game call barrel 1 also may have an opening 35 extending through the improved game call barrel 1, the opening 35 including an inlet 40 and an outlet 45. The improved game call barrel 1 may be made of a wood, polymer, metal, or other material suitable for game call barrels. The improved game call barrel 1 can be made from a monolithic piece of material, or can consist of multiple pieces joined together through any means known in the art.

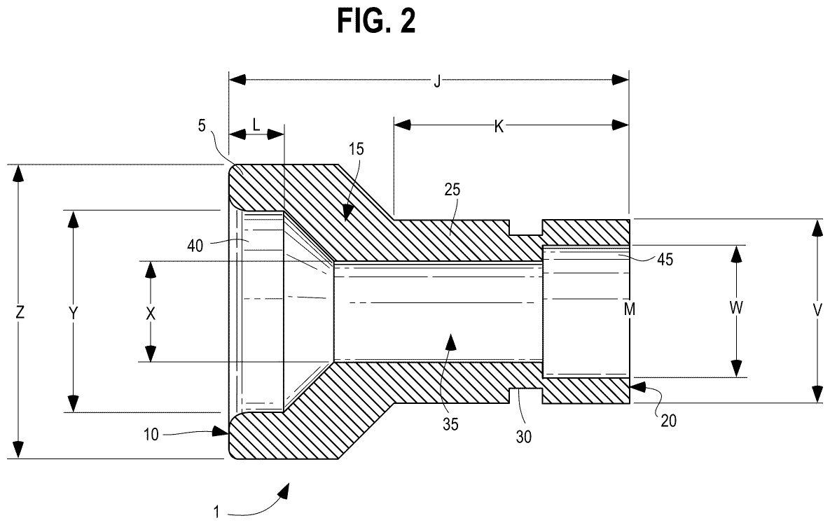

FIG. 2 illustrates dimensions of embodiments of the improved game call barrel 1. In one embodiment, a barrel length J may be between 2.5 and 3 inches. A mouthpiece length L may be between 0.25 and 0.5 inches, a body region length K may be between 1.5 and 2.0 inches. An outlet length M may extend 0.5 to 0.75 inches into the body region 25.

In one embodiment the mouthpiece 5 may have an outer mouthpiece diameter Z between 1.5 inches and 2.5. The inlet diameter Y may be between 1.25 and 1.5 inches. Thus, the outer mouthpiece diameter Z may be large enough to surround a user's lips when the improved game call barrel 1 is entirely or substantially in use. This may allow a user to maintain a substantially airtight seal with the mouthpiece 5 while delivering the air and sounds required to make a call with the improved game call barrel 1. Specifically, this helps with making certain game calls, including that of a diver duck and a sandhill crane. The mouthpiece 5 can be sized to accommodate the mouth size of a variety of users. The compression region 15 may be defined on the proximal end 10 by the mouthpiece 5 and on the distal end 20 by the body region 25. The compression region 15 is preferably tapered to reduce the mouthpiece outer diameter Z on the proximal end 10 of the compression region 15 to an outer body region diameter V on the distal end 20 of the compression region 15. Additionally, the diameter of the opening 35 is preferably tapered from the from the inlet diameter Y at the proximal end 10 of the compression region 15 to an internal body region diameter X at the distal end 20 of the compression region 15. The outer body region diameter V may be between 1.0 and 1.5 inches and the internal body region diameter may be between 0.5 and 0.75 inches.

The outlet 45 may be configured to accept a standard game call insert (not shown), which may include a tone board, a reed, and a wedge. An outlet diameter W may be sized to accept a variety of inserts and may be between 0.75 inches and 1.15 inches. The internal body region diameter X and outlet diameter W are preferably sized to produce game call sounds when paired with an appropriate insert.

In another embodiment of the improved game call barrel 1, the barrel length J is 2.75 inches. The mouthpiece length L is 0.38 inches. The body region length K is 1.63 inches. The outlet length M is 0.61 inches. The outer mouthpiece diameter Z is 2.00 inches. The inlet diameter Y is 1.38 inches. The internal body region diameter X is 0.69 inches. The outlet diameter W is 0.90 inches. The outer body region diameter V is 1.25 inches. The compression region 15 has a gradient linking the inlet diameter Y to the internal body region diameter X.

In use, a user may insert a standard game call insert (not shown) into the improved game call barrel 1. Once inserted, the user may form a seal between the mouthpiece 5 of the improved game call barrel 1 with their lips. The user may produce air and sound into the mouthpiece 5 to mimic the sound of game animals. In some embodiments the game animals may be waterfowl, and more specifically may be sandhill cranes or diver ducks.

While the embodiments above discuss waterfowl calls, specifically diver duck and sandhill crane calls, the improved game call barrel 4 can be used to make any type of game call, particularly where a having mouthpiece 8 that surrounds or partially surrounds a user's mouth is preferable. This may include rabbit, deer, coyote, elk, moose, bear, fox, other animal calls, and other bird calls.

In other embodiments, other configurations are possible. For example, those of skill in the art will recognize, according to the principles and concepts disclosed herein, that various combinations, sub-combinations, and substitutions of the components discussed above can provide an improved game call barrel.

What is claimed is:

1. A game call barrel comprising:
a mouthpiece having an inner diameter between 1.25 and 1.5 inches;
a compression region coupled at a first end to the mouthpiece; and
a body region coupled to a second end of the compression region opposite the mouthpiece.

2. The game call barrel of claim 1, wherein an outer diameter of the mouthpiece is between 1.5 and 2.5 inches.

3. The game call barrel of claim 1, wherein a length of the improved game call barrel is between 2.5 and 3.0 inches.

4. The game call barrel of claim 1, wherein the body region includes a lanyard ring circumscribing an outer surface.

5. The game call barrel of claim 1, wherein the ratio of the inner diameter of the mouthpiece to an internal body diameter is between 1.66 and 3.0.

6. The game call barrel of claim 1, wherein the mouthpiece has an internal diameter that is larger than the internal diameter of the body region.

7. The game call barrel of claim 1, wherein the body region further comprises an outlet region, the outlet region located on an end of the body region opposite the mouthpiece and having an internal diameter that is larger than an internal diameter of the body region.

8. The game call barrel of claim 7, wherein the internal diameter of the outlet region is between 0.75 and 1.15 inches.

9. The game call barrel of claim 1, further comprising an insert coupled to the body region opposite the mouthpiece and extending into the body region, the insert comprising:
a tone board;
at least one reed; and
a wedge.

10. A game call barrel comprising:
a mouthpiece with a length between 0.18 and 0.58 inches, an outer diameter between 1.5 and 2.5 inches, and an inlet diameter between 1.18 and 1.58 inches; and
a body with a length between 1.43 and 1.83 inches, an internal diameter between 0.49 and 0.89 inches, and an external diameter between 1.05 and 1.45 inches;
the body including an outlet portion with a length between 0.41 and 0.81 inches and an internal diameter between 0.75 and 1.15 inches;
a compression region coupled to the mouthpiece on one side, and the body on a second side;
the compression region having a length between 0.54 and 0.94 inches;
wherein the improved game call barrel has a length between 2.5 and 3.0 inches.

11. The game call barrel of claim 10, wherein the compression region tapers inwardly from the inlet diameter to the internal diameter of the body.

12. The game call barrel of claim 10, wherein the body includes a lanyard ring circumscribing an outer surface.

13. The game call barrel of claim 10, further comprising an insert coupled to the body opposite the mouthpiece and extending into the body, the insert comprising:
a tone board;
at least one reed; and
a wedge.

14. A method for using a game call barrel comprising:
coupling an insert into an end of the improved game call barrel opposite a mouthpiece, the mouthpiece having an outer diameter between 1.5 and 2.5 inches;
forming a seal between a user's lips and the mouthpiece; and
producing air and sound into the mouthpiece to mimic a sound of a game animal.

15. The method for using the game call barrel of claim 14, wherein the sound of a game animal mimicked is that of a diver duck.

16. The method for using the game call barrel of claim 14, wherein the sound of a game animal mimicked is that of a sandhill crane.

17. The method for using the game call barrel of claim 14, wherein the mouthpiece has a diameter of 2 inches.
